(19) United States
(12) Patent Application Publication
(10) Pub. No.: US 2014/0011594 A1
(43) Pub. Date: Jan. 9, 2014

(54) Electronic Social Trivia Game and Computer Application and Related Methods

(71) Applicant: Daniel Diaz, Miami, FL (US)

(72) Inventor: Daniel Diaz, Miami, FL (US)

(21) Appl. No.: 13/928,682

(22) Filed: Jun. 27, 2013

Related U.S. Application Data
(60) Provisional application No. 61/668,171, filed on Jul. 5, 2012.

(51) Int. Cl. G07F 17/32

(52) U.S. Cl. CPC G07F 17/32
USPC 463/42

(57) ABSTRACT

An electronic social trivia network system that allows multiple parties to engage in matches of trivia contests from remote locations. The social network further permits electronic trivia access without the need for specific hardware. The network also provides means for participants to author questions and host trivia games. A related software program or “app,” designed for at personal computing or communications devices is downloadable to be installable on multiple hardware platforms therefore eliminating the need for dedicated trivia hardware. Participants in the social trivia network can chat, play trivia, create games, join games, and maintain game records.

### CROSS-REFERENCE TO RELATED APPLICATION

This application claims the benefit of U.S. Provisional Patent Application Ser. No. 61/668,171 filed on Jul. 5, 2012 titled “Electronic Social Trivia Game and Computer Application and Related Methods,” the contents of which are incorporated by reference herein.

### FIELD OF THE INVENTION

The present invention relates to the field of trivia games and, more particularly, to computer-based trivia games.

### BACKGROUND

Trivia games are popular pastimes involving the asking and answering of questions. Questions can broadly cover multiple topics, such as found in traditional trivia board games, or be specific to a particular topic, such as sports-based trivia.

Trivia games are often played face-to-face in the form of board games. This requires actual possession of that particular game, and it requires that all involved coordinate to be at the same location at the same time. Additionally, electronic trivia games and board games come with a limited number of pre-loaded questions, so there is always a risk of running out of new questions.

Another form of popular trivia game is found at bars and restaurants where patrons of these establishments join ongoing trivia games. This “bar trivia” typically uses dedicated electronic interfaces that allow interaction with the game, the questions from which are displayed on nearby television screens or monitors. This requires costly specialized trivia equipment be purchased by the establishment and limits participation to times when the patron is present at the establishment. Additionally, bars that broadcast popular sporting events often remove the possibility to play trivia and instead dedicate televisions necessary to display trivia to such events.

In both board game trivia and bar trivia the participants are at the mercy of question writers, and only participate as answerers of questions—not authors of questions. This precludes specialized trivia that would not have broad audience appeal, yet would be quite appealing to a small subset of the population.

### SUMMARY

In view of the foregoing, it is an object of the present invention to provide a computer-based system and related method to play trivia over a network, such as the Internet. Advantageously, the system and method allows players to create their own questions. This allows users to create custom trivia matches and to expand trivia game offerings to niche topics. Additionally, a social element is added by allowing social communication between players.

In particular, the invention provides an online system for providing a multiplayer trivia game. The system has at least one trivia gaming client with at least one computer containing at least one processor and memory containing programming instructions (programming logic) to host a multiplayer trivia match. In a preferred embodiment, the clients comprise execute simultaneous independent matches. A network provides communications to and from the gaming clients. In one embodiment, the network comprises at least one centralized server that communicates with the trivia gaming clients.

Each user interface has at least some programming instructions to display trivia game controls and receive a user's input and send a user's input to other gaming clients. For example, when one client transmits trivia questions that are displayed to at least some of the gaming clients, responses to the displayed trivia questions are subsequently received and transmitted.

Advantageously, the trivia system provides trivia questions in multiple choice format. In this instance, the system also has the necessary programming instructions to display a list of potential answers and to transmit a selected answer to at least some of the gaming clients participating in the game. The user interface further has programming instructions to create a summary of answers from the trivia clients and to display the summary of the selected answers.

Gaming clients are individually eliminated from match participation upon transmitting an incorrect answer. In another type of play, the gaming clients eliminated from match participation may transmit an incorrect answer appeal, and the client transmitting the trivia questions comprises a dialogue to grant or reject the answer appeal.

In a team match embodiment, the gaming clients participating in a match are divided to comprise a plurality of teams. These user interfaces may further create a summary of answers from the plurality of teams, transmit the selected answer, and display a team summary of the selected answers.

The system may also provide provisions where the client that transmits trivia questions also controls a trivia match rule set. The match rule set has parameters to set an answer timer, a turn timer, maximum number of players for a match, and the score threshold necessary to declare a match winner.

The invention also provides a method for operating a multiplayer trivia game comprising the steps of: registering at least one trivia gaming client; providing a network for hosting a trivia match that provides communication to and from the gaming clients; providing a user interface with the gaming clients for playing the trivia match; designating one of the gaming clients a match host client; initiating a trivia match with some of the gaming clients; receiving a trivia question from the match host client; sending the trivia question to at least some of the trivia gaming clients; receiving a set of responses from some of the gaming clients; creating a summary of the set of responses; and sending the summary of the set of responses to some of the trivia gaming clients.

The method also includes the step of calculating a match score for the at least some of the gaming clients. The match score is based on the number of correct responses reported in the summary of the set of responses. The method for operating a multiplayer trivia game may further comprise the step of eliminating each client that sends an incorrect answer in response to a trivia question.

A team play method is also provided, wherein the method includes designating at least some of the gaming clients to a first team, and designating at least some of the plurality of trivia gaming clients that are not on the first team to a second team, wherein the trivia match is between the first team and the second team.

The method for operating a multiplayer trivia game further comprises the step of providing the match host client a user interface to transmit a trivia match rule set comprising: parameters for an answer timer; a turn timer; a maximum number of players permitted in a match; and a score threshold necessary to declare a match winner.

Also provided, is a method for operating a multiplayer trivia game comprising the steps of: downloading a trivia gaming software application for installation onto a mobile device; connecting to a trivia network with the mobile device to play a trivia match; communicating with the trivia network from the mobile device; initiating a trivia match; inviting additional players to the trivia match; providing questions to the additional players for the trivia match; and receiving a summary of a set of question responses from the additional players.

The method may further comprise the steps of: setting a turn timer, setting a maximum number of players for a trivia match; and setting a score threshold necessary for the network to automatically declare a trivia match winner.

These and other objects, aspects, and advantages of the present invention will be better appreciated in view of the drawings and the following detailed description of the embodiments.

### BRIEF DESCRIPTION OF THE DRAWINGS

For a fuller understanding of the invention, reference is made to the following detailed description, taken in connection with the accompanying drawings illustrating various embodiments of the present invention, in which:

FIG. 1 is a schematic illustration of an embodiment of an electronic social trivia system of the present invention;

FIG. 2 is an illustration of a screenshot for an embodiment of the home page module of the electronic social trivia system of the present invention;

FIG. 3 is an illustration of the procedure for the registration and login process of the electronic social trivia system of the present invention;

FIG. 4 is an illustration of a screenshot for an embodiment of the Matches module of the electronic social trivia system of the present invention;

FIG. 5 is an illustration of a screenshot for an embodiment of the Create Match module of the electronic social trivia system of the present invention;

FIG. 6 is an illustration of a screenshot for an embodiment of the Create Question module of the electronic social trivia system of the present invention;

FIG. 7 is an illustration of the process for trivia match play of the electronic social trivia system of the present invention; and

FIG. 8 is an illustration of the procedure for the appeal process of the electron social trivia system of the present invention.

Like reference numerals refer to like parts throughout the several views of the drawings.

### DETAILED DESCRIPTION

Reference is made to particular features (including method steps) of the invention. It is to be understood that the disclosure of the invention in this specification includes all possible combinations of such particular features. For example, where a particular feature is disclosed in the context of a particular aspect or embodiment of the invention, that feature can also be used, to the extent possible, in combination with and/or in the context of other particular aspects and embodiments of the invention, and in the invention generally.

The term “comprises” is used herein to mean that other elements, steps, etc. are optionally present. When reference is made herein to a method comprising two or more defined steps, the steps can be carried in any order or simultaneously (except where the context excludes that possibility), and the method can include one or more steps which are carried out before any of the defined steps, between two of the defined steps, or after all of the defined steps (except where the context excludes that possibility).

In this section, the present invention will be described more fully with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will convey the scope of the invention to those skilled in the art.

In view of the foregoing background, it is therefore an object of the present invention to provide a computer implemented method, system and software for an electronic social trivia network that allows multiple parties to engage in matches of trivia contests from varying locations. The network further permits electronic trivia access without the need for specific hardware. The network also provides means for participants to author questions and host trivia games.

The computer implemented method, system and software may include an application, “app,” designed for at least one of a smart phone, computer, laptop, tablet computing device, and portable electronic gaming systems. The app may be downloadable to be installable on multiple hardware platforms (e.g. without limitation, iPhone®, Android™, Windows Mobile®, BlackBerry®, etc.), therefore eliminating the need for dedicated trivia hardware. Nevertheless, as it would be understood by those skilled in the art the computer implemented method, system and software could be utilized on a dedicated hardware device, such as a portable gaming device.

As used herein, the term “computing device” refers to any electronic communications device with a processor and memory that is capable of running an application comprising the software modules of the present invention, such as a smartphone, hand-held computer, laptop computer, desktop computer, terminal, PDA (Personal Digital Assistant), network computer, wireless communicator (such as a cellular or satellite telephone), or a multi-user computing system, etc. which is capable of communicating with a remote network, such as the internet. The computing device further comprises a graphical interface that may display an image of the trivia game during play.

The application program provides full functionality of the present invention to run software modules on the user's device or on the system server. Alternatively, the application may be accessed at a third party website (e.g., Facebook) and/or in chatrooms.

As used herein the term “server” is used to describe any computer that stores and runs a computer program, or software, of the present invention, houses the system database, and communicates periodically with the software stored and executed on users' computing devices. The server facilitates the collection and distribution of content to and from one or more users' computing devices. The server computer consists of one or more CPU's (Central Processing Units), memory components (i.e., RAM (Random-Access Memory)), and one or more storage devices (i.e., hard disk drives).

As used herein, the term “software” or “application” comprises programming instructions adapted for execution by a hardware element, such as a processor of a computing device, wherein the instruction comprises commands that, when executed, cause the processor to perform a corresponding set of commands. The software may be written or coded using a programming language, and stored using any type of computer-readable media or machine-readable media well known in the art. Examples of software referred to herein in the present invention comprise any software components, programs, applications, apps, modules, computer programs, application programs, system programs, database management programs, machine programs, and operating system software. Furthermore, the software may be a web application that resides on the system server and is accessed via the Internet. It performs the same tasks as a native application, usually by downloading part of the application to the device for local processing each time it is used.

### Electronic Social Trivia Network Framework

The application and the system comprise at least one processor and computer readable medium containing computer executable instructions to carry out the methods of the present invention.

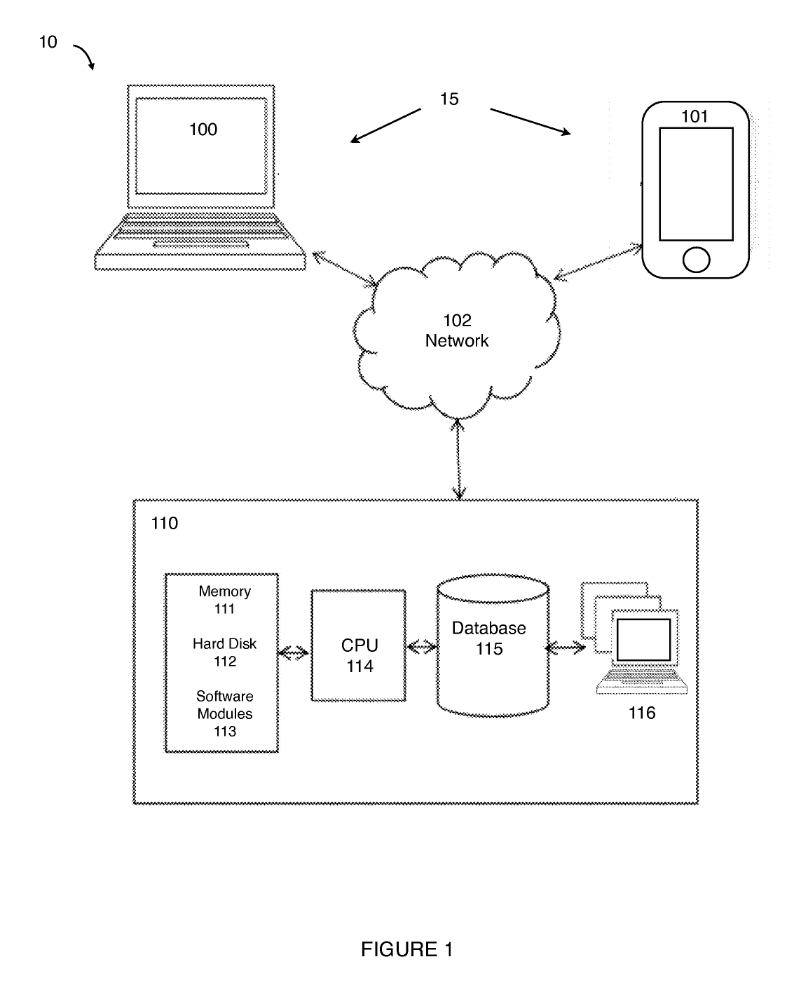

As illustrated in FIG. 1, the application and system, generally referred to as 10, may comprise online trivia software modules 113 that interface with a wireless network to allow users of computing devices 100, 101 to create their accounts, access a remote server, and play against others that are also interfacing with the server 110, etc., over a network 102.

The term “network” is used to describe any public network, such as the internet or World Wide Web or any public or private network as may be developed in the future which provides a similar service as the present internet. The user's computing device may connect to the network via a variety of methods, including but not limited to, a network card, wireless network (cellular, satellite, infrared, radio, Bluetooth®, etc.), Local Area Network (LAN), Wide Area Network (WAN), or any such means as necessary to communicate to a server computer connected directly or indirectly to the network.

The present invention comprises one or more computing devices 100 and 101 in communication via a network 102 with a server 110 made up one or more computers 116 containing memory 111 and at least one processor (i.e., CPU) 114 that house software modules 113 for online trivia gaming and a database 115 that contains user records. In some embodiments of the present invention software program runs on the server 110 and is accessed through the user's computing device's 100, 101 web browser.

The server 110 comprises at least one computer 116 and a means for connecting to the network 102 (i.e., network card). The computer 116 comprises memory 111, such as random access memory (RAM) for program execution, a hard disk 112 for program storage (the hard disk could be any such device capable of storing data, including flash drives, removable media, etc.), one or more central processing unit (CPU) 114, and a database 115 of users records comprising their trivia game account information. The server 110 may also comprise web server software and gaming management software of the present invention. It is also contemplated by the present invention that the server 110 may further include software modules 113 of the present invention that are executed from the server 110 as users interact over the network 102 via their various computing devices 100, 101.

The software execution files may comprise limited usage programming instructions, which may serve to restrict access to the trivia game by a user. The limited usage programming instructions may enable a user to play the trivia game as long as there are no restrictions. Restrictions may include, but are not limited to, parental restrictions, delinquent membership account, abuse of terms of service, and account closure.

In one aspect, the online computer system 10 for providing a multiplayer trivia game comprises at least one trivia gaming client 15 comprising at least one computing device 100, 101 with at least one processor and machine readable memory configured with programming instructions (software) to host a multiplayer trivia match; a network 102 comprising at least one server 110 that provides communication to and from the trivia gaming clients 15; and a user interface with the trivia gaming clients 15. The network 102 comprises at least one centralized server 110 that communicates with the trivia gaming clients 15, and the network 102 may optionally include programming instructions to time stamp the turn timer if a client disconnects from the network 102 and programming instructions to subtract elapsed time once the client reconnects to the network 102. The trivia gaming clients 15 also comprise programming instructions to execute simultaneous independent matches.

The user interface contains programming instructions to display trivia game controls and programming instructions to receive users' input and to send users' input to at least some of the trivia gaming clients 15. At least one client transmits trivia questions and at least one of the trivia gaming clients transmits potentially correct responses to the trivia questions.

The system 10 also includes programming instructions to display a list of potential responses. The system 10 may further allow transmission of a selected response to at least some of the trivia gaming clients. Furthermore, the system 10 may include ability to create a summary of selected responses from at least some of the trivia gaming clients 15 that transmit the selected response and ability to display the summary of the selected responses.

At least some of the trivia gaming clients 15 transmitting an incorrect response during participation comprise programming to optionally transmit an incorrect response appeal, and the client transmitting trivia questions comprises a dialogue to grant or reject the response appeal.

### Electronic Social Trivia Network User Interface

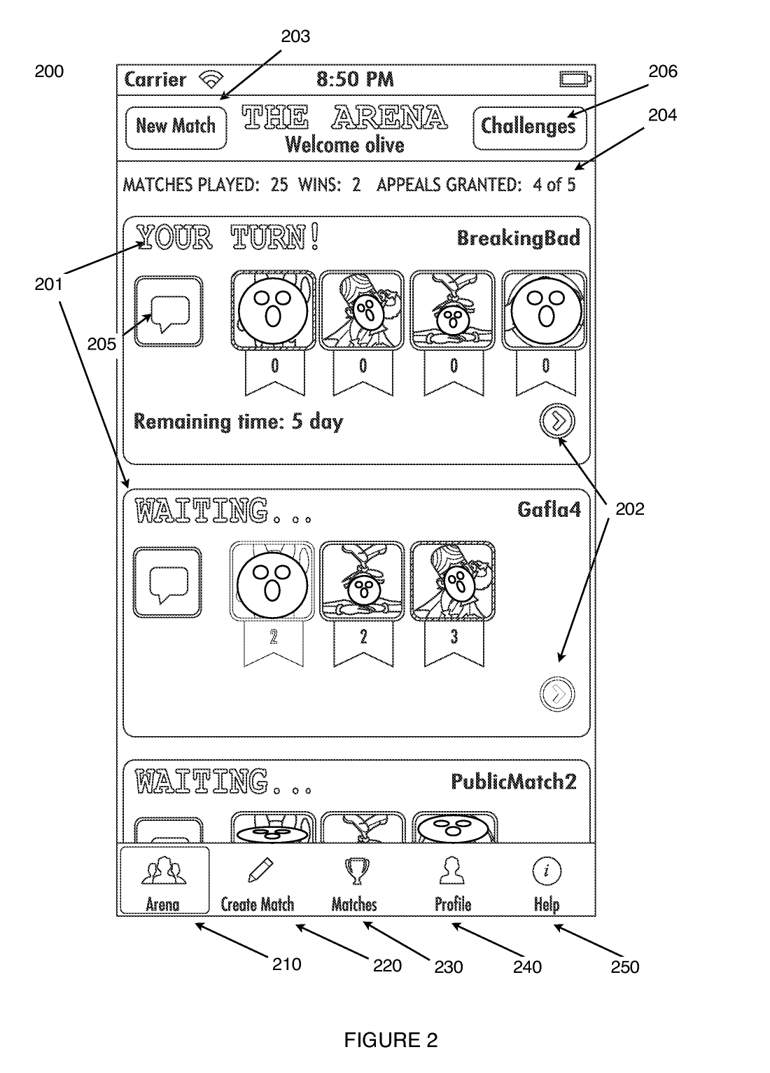

The system 10 is navigated by a user interacting with an electronic user interface that is preferably graphical. FIG. 2 illustrates an exemplary screen shot of a software module 113 of the system, namely the home page, or “arena,” module 200. This module is the interface location wherein network participants receive notifications 201, access open matches 202, access or initiate new matches 203, view match and appeal summaries 204, initiate chat with other network participants 205, access game challenges 206 and perform other interactions necessary to participate in the gaming network.

Interactive tabs are also presented on each of the modules 113 that allows a user to select a specific module 113 to access. For example, there may be a tab for Arena 210, which provides access to the home page (arena) module 200; Create Match 220, which provides access to the Create Match module 530; Matches 230, which provides access to the Matches module 410; Profile 240, which provides access to a module for inputting and displaying user information; and Help 250. The Help 250 tab is utilized for access to a module for providing assistance regarding rules and other aspects of the system and software.

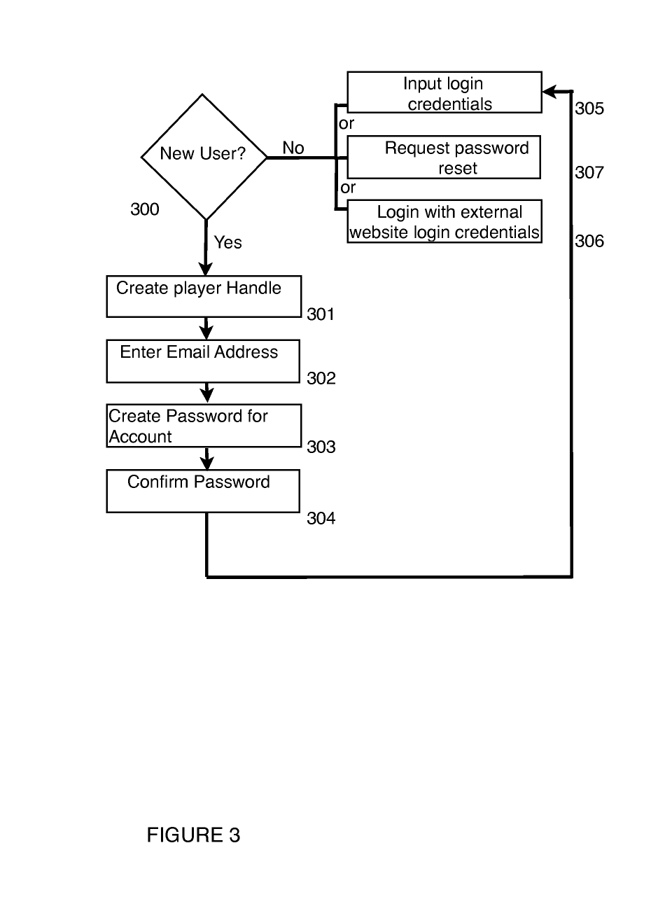

A user account is needed to participate in the trivia gaming network. Users input personal information, which may be a compilation of information that may include personal data, social media data, mobile network data, and payment data. The user account is saved on the server 110. As illustrated in FIG. 3, it is first queried whether the user is a new user or returning user 300. If a new user, the user is provided with interfaces to create a player handle 301, enter an email address 302, create a password for the account 303, and confirm the password 304. Once a player is registered in the network, login credentials are input 305. Login may also be achieved through input of external website login credentials 306, such as Facebook®, MySpace®, etc. In the event a password is forgotten, users are queried with ability to request a password reset 307.

Personal data saved includes at least one of, without limitation, name, screen name, avatar, address, phone numbers, email addresses, or any other data used to describe or identify an individual user. Social media data may be saved, which may include account login information, handles or usernames, social network preferences, or any other information related to social media use and accounts. Mobile and communication data may be saved, which may include SMS contact information, geo-location data, voice over internet protocol (VoIP) information, or any other information related to mobile communications, communication technology, and related devices. Payment system data may be saved, which may include credit card information or online payment system information or direct access to financial institutions such as Paypal® or Google® checkout, credit card accounts, bank accounts, credit card processors, electronic banking, or any other financial information or access.

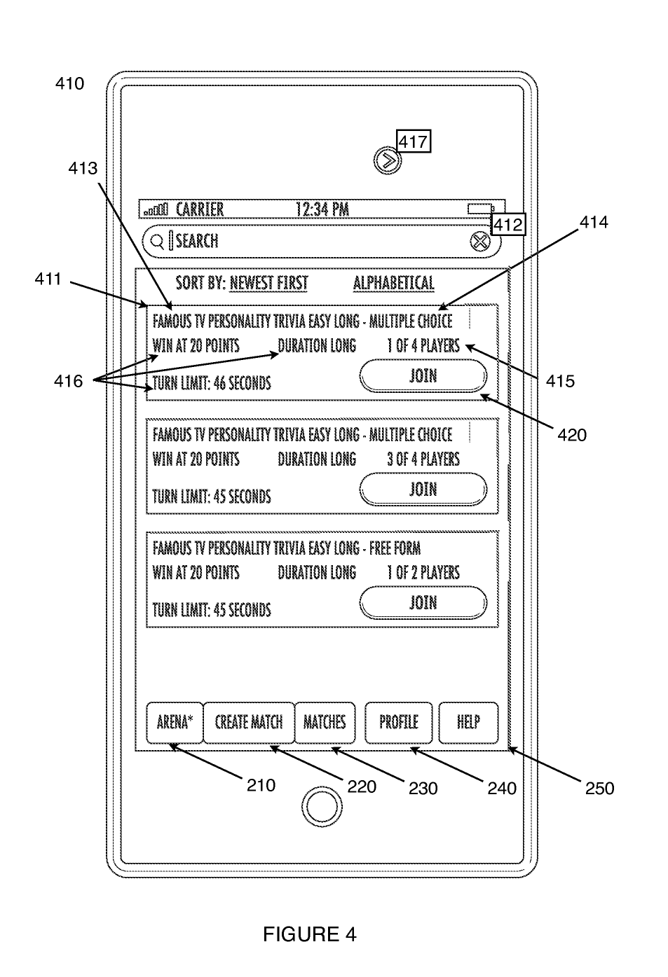

FIG. 4 illustrates an exemplary screen shot of another software module 113 of the system. The module 113 shown is the matches module 410, which lists several trivia game matches 411 that may be joined by selecting the JOIN button 420 on the screen that corresponds to the trivia game match 411 that a user wishes to join. The user can also perform a search of all trivia game matches 411 that are available to join by entering keywords in the search bar 412 to search the gaming network. Each of the trivia game matches 411 that is listed includes the trivia category 413, question format 414, number of players 415, and match rules 416. There is also a BACK button 417 to return to the previously viewed screen module.

Participants create trivia game matches, and have control over many aspects of the game, such as a trivia match rule set to create custom gaming experiences. Participants dictate, inter alia, match rules, trivia category, style of questions asked, and the questions themselves. A primary objective of participating in trivia matches is to win the match and accumulate points, which are recorded and displayed by the network. Furthermore, participants will determine whether a trivia match will be open to any of the plurality of trivia gaming clients 15 thus public, or be private and accessible by challenge, or invitation, only. Participants will also determination which trivia gaming clients 15 are allowed to take part in a game. Typically, the trivia gaming client 15 that creates the customized trivia match also controls the aforementioned trivia match rule set characteristics.

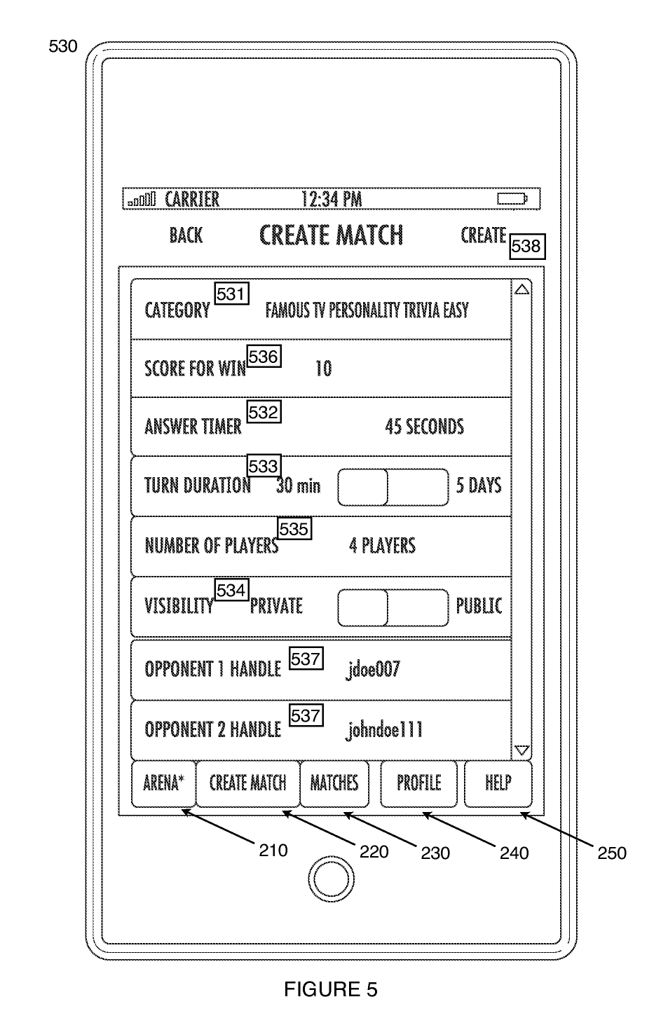

FIG. 5 illustrates an exemplary screen shot of a create match module 530 of the system that is accessed from the Create Match 220 tab. The screen has several fields and toggle switches to set match attributes. The creator of the match determines the category 531 of the questions, the question format, a response timer or the time allotted for answering each question (“answer timer”) 532, a turn timer or the time allotted for the next player (“turn timer” or “turn duration”) 533 in succession to ask their questions, public or private match attributes (“Visibility”) 534, the maximum number of participants (“Number of Players”) 535, the number of questions answered correctly needed reach a score threshold necessary to declare a winner of the match (“Score for Win”) 536, and any other relevant options or constraints. Instead of creating a match, participants may also join matches created by other users of the network. If the match is to be a private match, Opponent Handles 537 may be entered for the private match participants. Once the match attributes are entered, the user selects the Create tab 538 to create the match.

Participants creating a question for a match are prompted to input questions and the corresponding correct responses/answers. This question will be posed, during a match, to other players. The format of the question is either multiple choice or free response, which is also determined by the question creator. Participants transmit trivia questions in turn.

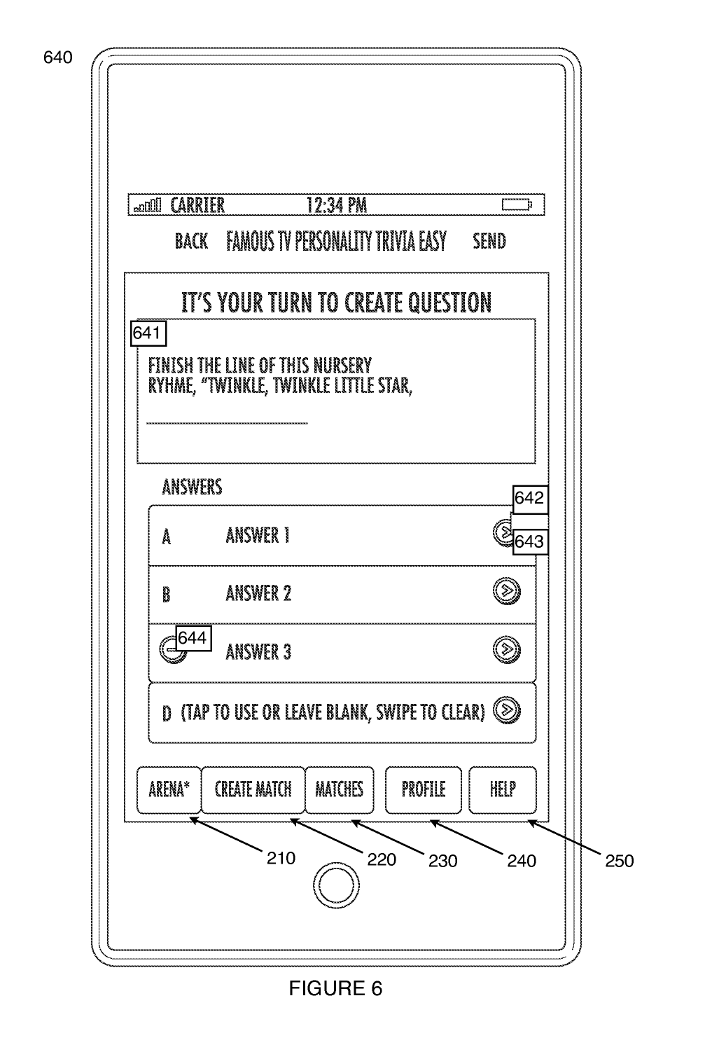

FIG. 6 illustrates an exemplary screen shot of a create question module 640 of the system. The user creating a question is prompted for a question at the question creation prompt 641. For multiple choice questions, two (or more) answer choices are entered by the question creator that will be displayed during match play by selecting an appropriate answer input prompt 642, only one of the answers being correct. The answer inputs are toggled by selecting a corresponding arrow prompt 643 or deleted by swiping the screen at the input prompt to be deleted and selecting the erase prompt 644.

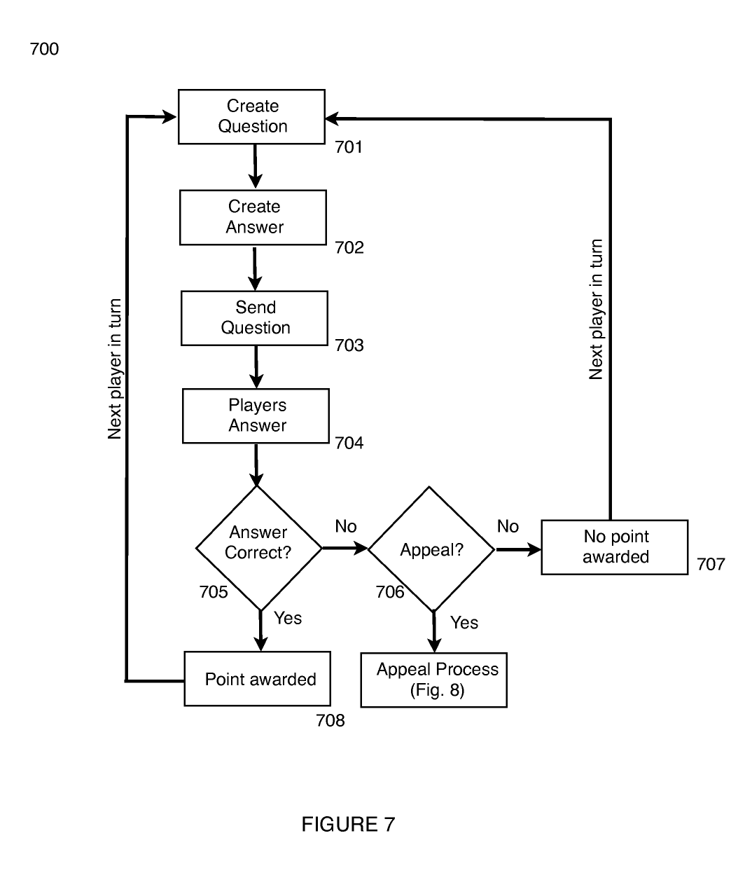

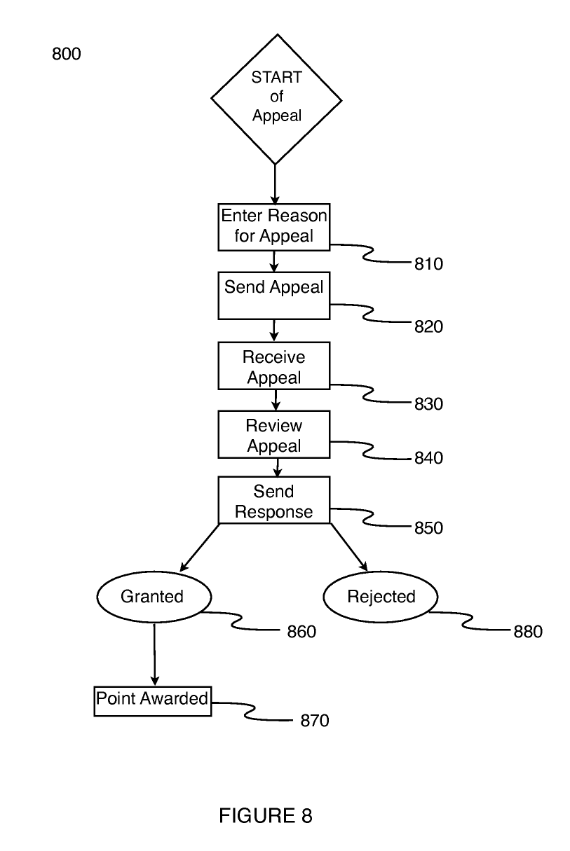

Turning now to FIG. 7, where the process for trivia match play 700 is shown, participants take turns creating questions 701 and answers 702 and submitting the questions 703 to other participants during match play. Participants are presented with the question and must choose from one of the answers presented 704 (if in multiple choice format), attempting to choose the correct answer. Once the question is displayed, an answer timer begins to count down. Once the count down reaches zero, the turn is ended, whether a correct answer choice is made or not. This time constraint keeps the game play paced, and helps to prevent participants from using outside help to answer questions. It is next determined whether each of the participants answers correctly 705. If one of the participants answers correctly, that participant is awarded a point 708. If any of the participants do not answer correctly, the respective participants are given the option to appeal the question 706 (see FIG. 8). If no appeal is taken, the participant does not receive a point 707. Gameplay continues by the next participant in turn creating the next question 701 and answer 702 utilizing the create question module 640. In multiple participant matches, each person asks questions, taking turns to do so in succession.

In free response questions, a singular answer is entered by the question creator. During game play, the answer must be input into a text field, and the answer is compared to the answer entered by the question creator. In a preferred embodiment, the software and system automatically compares the answer input into to the text field with the answer entered by the question creator. An algorithm determines whether the input text is a match (i.e. correct answer), ignoring punctuation, capitalization, spaces, and minor misspellings. Once the question is displayed, an answer timer begins to count down. Once the count down reaches zero, the turn is concluded. This time constraint keeps the game play fast, and helps to prevent participants from using outside help to answer questions. In one embodiment, after a participant guesses an answer to a free response question, the roles are switched, and the previous asker of a question must answer the next question, and a previous answerer must now present a different question. In multiple participant matches, each person typically asks questions, but taking turns to do so in succession.

Questions may also have media, such as audio, one or more photographs, sounds, videos, and combinations thereof, associated with the questions and uploaded by the user authoring the question. As part of the interface, a smartphone can be used to take a picture or video, for example, and then edited and attached to a question.

When a dispute arises during match play the system comprises an appeal option that may be exercised (assuming the appeal option is allowed, based on the game creator's choice of match options), as illustrated in FIG. 8. Questions and answers have the potential to be unclear, poorly worded, ambiguous, and answers may be input with incorrect answers by the question creator. The appeal 800 option is incorporated into match play, so that match participants may appeal questions and answers regarded as incorrect. First, a reason for the appeal is provided, 810, and sent to the question creator, 820. Once the question creator receives, 830, and reviews, 840, the reason for appeal, the question creator sends a response, 850. If the appeal is granted, 860, the participant receives credit for a question answered correctly and is awarded a point 870. Moreover, a rejected appeal, 880, receives no point. Statistics regarding the number of appeals requested and the number of appeals won are recorded for all participants (both as question creators and answerers) to indicate the general quality of the questions asked by that particular player.

The turn timer dictates the time constraint placed upon the participants answering questions. Once a participant in a match is presented with a question, the turn timer starts. The turn timer is a countdown timer that displays the time left for a participant to answer a question after a question is presented to that participant. Additionally, after the participant answers the question, they must then post a question to ask of their own. Filing a player appeal must also be done before the turn timer lapses. These tasks must be accomplished within the time constraints of the turn timer, and if they are not, that player's turn is forfeited and no credit is awarded for a correct answer proffered. This is considered a “skipped” turn. If a predetermined number of skips is incurred by a single player, three for example, that player will be automatically disqualified from the match. This is recorded in that player's statistics. An appeal, however, halts the turn timer and begins a new turn timer for the participant to whom the appeal is directed. If that participant fails to address the appeal in the time allotted, the appeal is automatically granted.

It should be noted that the network time-stamps all game events, so once a question is asked, a time stamp is recorded. This time stamp is used to calculate turn and answer timers. This is important so that a user can not exit the game to halt a timer, perform research on their smartphone, for example, and then continue the game with the proper answer gleaned from a search engine.

Additional forms of matches disclosed by the present invention include elimination matches and team matches. Elimination matches are matches created by a single game creator (i.e. “QuizMaster”) wherein participants answer questions posed by the QuizMaster. The QuizMaster does not answer questions. Each round, a single question is asked, and all of the participants attempt to provide a correct answer. If a participant provides an incorrect answer, they are eliminated from the match. If a participant provides a correct answer, they advance to the next questions round. This is repeated until the game is over. The game is over when only one player remains. In the case where all remaining participants answer incorrectly, instead of eliminating all participants, all participants remain in the match to face the next round. If a player does not answer before their turn timer runs outs, that player is eliminated. Additionally, “free for all” style trivia is available, wherein players fight to see who can correctly answer a question first, and earning points in doing so.

Team matches are matches wherein a plurality of participants is associated with a particular team for purposes of game play. In the team match mode of play, each player submits a question for a particular round of play, and these questions are randomly assigned to participants on an opposing team. Imbalances in the number of participants (typically only a difference of one player is permitted) between teams are handled by randomly assigning two questions to a single player on the answering team. Additionally, a single participant is randomly assigned to ask two questions if the questioning team has player deficit. Upon being asked to answer questions, the team members must each respond, earning credit only for questions answered correctly. After answering a question(s) the participant is required to submit a question for the following round. The turn timer stops running when all members have answered all questions, and the last team member of a particular team has submitted their question(s). If a player fails to provide a question following their answer, no credit is awarded for a correct answer. The teams take turn answering and providing questions, and the game ends in victory for a team when a predetermined number of correct question credits have been earned.

Challenges may also be issued as part of match creation, wherein players may enter another player's username or email address to specifically target that player for invitation to a game match, as illustrated in FIG. 5, Opponent Handles 537.

### Methods for Operating a Multiplayer Trivia Game

In another aspect of the present invention, a method for operating a multiplayer trivia game is presented. The method comprises one or more of the steps of: registering at least one trivia gaming client; providing a network comprising at least one computer for hosting a trivia match that provides communication to and from the trivia gaming clients; providing a user interface with the trivia gaming clients for playing the trivia match; designating one of the trivia gaming clients a match host client; initiating a trivia match with at least some of the trivia gaming clients; receiving a trivia question from the match host client; sending the trivia question to at least some of the trivia gaming clients; receiving a set of responses from at least some of the trivia gaming clients; creating a summary of the set of responses; and sending the summary of the set of responses to at least some of the trivia gaming clients. The trivia questions from the match host client are in either multiple choice format or free response format.

In some embodiments, the method includes calculating a match score for the at least some of the trivia gaming clients based on the number of correct responses reported in the summary of the set of responses.

In additional embodiments, the method includes the step of providing the match host client a user interface to transmit a trivia match rule set comprising: parameters for at least one of an answer timer; a turn timer; a maximum number of players for a match; a determination of trivia gaming clients allowed to take part in a game; and a score threshold necessary to declare a match winner.

In another aspect of the present invention, a method is contemplated for operating a multiplayer trivia game comprising the steps of: downloading a trivia gaming software application for installation onto a mobile computing device; connecting to a trivia network with the mobile device to play a trivia match, the network comprising at least one networked computer; communicating with the trivia network from the mobile device; initiating a trivia match; inviting additional players to the trivia match; providing questions to the additional players for the trivia match; and receiving a summary of a set of question responses from the additional players. The method optionally includes the step of providing the match host client a user interface to transmit a trivia match rule set including at least one of setting a turn timer; setting a maximum number of players for a trivia match; and setting a score threshold necessary for the network to automatically declare a trivia match winner. The method also includes receiving notification that at least one of the additional players has met the score threshold.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed.

What is claimed is:

1. A computer system for providing a multiplayer trivia game comprising:
at least one trivia gaming client including at least one computing device with at least one processor and machine readable memory configured with programming instructions to host a multiplayer trivia match over a network;
a user interface for the trivia gaming client comprising:
programming instructions to display trivia game controls;
programming instructions to receive user input and to send user input;
wherein the at least one trivia gaming client transmits trivia questions.

2. The computer system for providing a multiplayer trivia game of claim 1, wherein the trivia questions are in multiple choice format.

3. The computer system for providing a multiplayer trivia game of claim 1, wherein the trivia questions are in a free response format.

4. The computer system for providing a multiplayer trivia game of claim 1, wherein the trivia questions and correct responses are authored and input into the at least one trivia gaming client by the user.

5. The computer system for providing a multiplayer trivia game of claim 4, wherein the trivia questions include media.

6. The computer system for providing a multiplayer trivia game of claim 5, wherein the media is selected from the group consisting of audio, one or more pictures, video, and combinations thereof.

7. The computer system for providing a multiplayer trivia game of claim 2, further comprising:
programming instructions to display a list of potential responses; and
programming instructions to transmit a selected response over the network.

8. The online computer system for providing a multiplayer trivia game of claim 3, further comprising:
programming instructions to transmit a selected response over the network.

9. The computer system for providing a multiplayer trivia game of claim 7, wherein the user interface further comprises:
programming instructions to create a summary of selected responses from at least some of the at least one trivia client that transmits the selected response; and
programming instructions to display the summary of the selected responses.

10. The computer system for providing a multiplayer trivia game of claim 8, wherein the user interface further comprises:
programming instructions to create a summary of selected responses from at least some of the at least one trivia client that transmits the selected response; and
programming instructions to display the summary of the selected responses.

11. The computer system for providing a multiplayer trivia game of claim 1, wherein:
at least one trivia gaming client transmitting an incorrect response during participation comprises programming instructions to optionally transmit an incorrect response appeal.

12. The computer system for providing a multiplayer trivia game of claim 1, wherein the trivia gaming client that transmits trivia questions also controls a trivia match rule set comprising parameters for at least one of a response timer, a turn timer, a maximum number of trivia gaming clients for a game, a score threshold necessary to declare a game winner, and determination of trivia gaming clients allowed to take part in a game.

13. The computer system for providing a multiplayer trivia game of claim 1, wherein the network comprises at least one centralized server that communicates with the plurality of trivia gaming clients.

14. The computer system for providing a multiplayer trivia game of claim 1, wherein the at least one trivia gaming client comprises programming instructions to execute simultaneous independent matches.

15. A method for operating a multiplayer trivia game comprising the steps of:
registering a plurality of trivia gaming clients over a network;
designating one of the plurality of trivia gaming clients a match host client;
initiating a trivia match with at least some of the plurality of trivia gaming clients over the network;
receiving a trivia question from the match host client;
sending the trivia question to at least some of the plurality of trivia gaming clients over the network;
receiving a set of responses from at least some of the plurality of trivia gaming clients;
creating a summary of the set of responses; and
sending the summary of the set of responses to at least some of the plurality of trivia gaming clients over the network.

16. The method for operating a multiplayer trivia game of claim 15, wherein the trivia question from the match host client is in multiple choice format.

17. The method for operating a multiplayer trivia game of claim 16, further comprising the step of calculating a match score for the at least some of the plurality of trivia gaming clients based on the number of correct responses reported in the summary of the set of responses.

18. The method for operating a multiplayer trivia game of claim 16, further comprising the step of transmitting a trivia match rule set comprising:
parameters for at least one of an answer timer;
a turn timer;
a maximum number of players for a match;
a determination of trivia gaming clients allowed to take part in a game; and
a score threshold necessary to declare a match winner.

19. A method for operating a multiplayer trivia game comprising the steps of:
downloading a trivia gaming software application for installation onto a mobile computing device;
connecting to a trivia network with the mobile device to play a trivia match;
communicating with the trivia network from the mobile device;
initiating a trivia match;
inviting additional players to the trivia match;
providing questions to the additional players for the trivia match; and
receiving a summary of a set of question responses from the additional players.

20. The method for operating a multiplayer trivia game of claim 19 further comprising the steps of:
setting a turn timer;
setting a maximum number of players for a trivia match; and
setting a score threshold necessary for the network to automatically declare a trivia match winner.

21. The method for operating a multiplayer trivia game of claim 20, further comprising the step of receiving notification that at least one of the additional players has met the score threshold.
